(19) United States
(12) Patent Application Publication
(10) Pub. No.: US 2015/0286776 A1
(43) Pub. Date: Oct. 8, 2015

(54) High Resolution Melt Analysis Workflow Graphical User Interface

(71) Applicant: Canon U.S. Life Sciences, Inc., Rockville, MD (US)

(72) Inventor: Bradley Scott Denney, Irvine, CA (US)

(21) Appl. No.: 14/677,115

(22) Filed: Apr. 2, 2015

Related U.S. Application Data
(60) Provisional application No. 61/974,840, filed on Apr. 3, 2014.

(51) Int. Cl. G06F 19/24; G01N 21/64; G06T 7/00

(52) U.S. Cl. CPC G06F 19/24; G06T 7/0012; G01N 21/6486; G06T 2207/10064; G06T 2200/24; G06T 2207/30072

(57) ABSTRACT

A method and a system for nucleic acid melting analysis are provided. Specifically, the system includes a biochip having at least one sample containing nucleic acids. A thermal generating apparatus ramps the temperature of the at least one sample to cause dissociation of the nucleic acids. A raw melting curve reflecting dissociation of the nucleic acids is generated. To analyze the raw nucleic acid melting curve, a normalization method is selected to define a mathematical relationship between a normalized melting curve and the raw melting curve. A derivative of the normalized melting curve is calculated based upon the mathematical relationship and a derivative of the raw melting curve obtained prior to calculating the normalized melting curve. Accordingly, the derivative of the normalized melting curve is calculated without using the Savitsky-Golay (SG) filter. The elimination of an additional SG filter in the melting analysis substantially reduces computation time.

### CROSS-REFERENCE TO RELATED APPLICATIONS

This application claims the benefit of priority to U.S. Provisional Patent Application Ser. No. 61/974,840, filed on Apr. 3, 2014, which is incorporated herein by reference in its entirety.

### BACKGROUND

1. Field of the Invention

The invention relates to nucleic acid High Resolution Thermal Melting (HRTₘ) analysis including analysis of nucleic acid melting curves. Specifically, the invention relates to optimization of existing algorithms used for analysis of nucleic acid melting curves by minimizing usage of Savitsky-Golay (SG) filters.

2. Discussion of the Background

Nucleic acid HRTₘ analysis is a complicated process that requires trained experts to manipulate melt fluorescence curves through a series of steps so that the curves finally generate visually meaningful information to the user. The user can then apply the visual and statistical information in a variety of diagnostic scenarios. There are many parameters and choices to be made in the workflow analysis. Often times when one parameter is changed, the entire workflow must be recalculated and depending on the settings of the parameters, this calculation can result in a noticeable delay between the change made and the results displayed.

The problem with the current user interface (UI) is that the results from changes can be slow to update and thus cannot be shown in real-time as the user is changing some parameters. More specifically, the workflow includes a curve smoothing and derivative calculation performed by an SG filter. The SG filter is a digital filter that can be applied to a set of digital data points for the purpose of smoothing the data, that is, to increase the signal-to-noise ratio without greatly distorting the signal. This is achieved by fitting successive sub-sets of adjacent data points with a low-degree polynomial by the method of linear least squares. When the data points are equally spaced an analytical solution to the least-squares equations can be found, in the form of a single set of “convolution coefficients” that can be applied to all data sub-sets, to give estimates of the smoothed signal or derivatives of the smoothed signal at the central point of each sub-set.

The SG filter is widely used in for chemistry and biology calculations. However, the SG filter can be slow (depending on the settings of the filter) and as such presents a processing bottleneck. Accordingly, there is a need for new algorithms employed for nucleic acid melt analysis to minimize the usage of SG filter.

### SUMMARY OF THE INVENTION

According to one aspect of the present invention, a method for nucleic acid melting analysis is provided. Specifically, the method is performed in conjunction with a biochip having at least one sample containing nucleic acids. The temperature of the at least one sample is ramped to cause dissociation of the nucleic acids. A plurality of images is acquired for each sample based on a fluorescence signal emitted by the nucleic acids during dissociation. Furthermore, the method comprises generating a raw nucleic acid melting curve for each sample based on the acquired images. The raw melting curve represents the fluorescence signal emitted by the nucleic acids as a function of the temperature.

In one embodiment, an equation defining a mathematical relationship between a normalized melting curve and the raw melting curve is provided to calculate the normalized melting curve. Next, a derivative of the normalized melting curve is calculated based on the equation and a derivative of the raw melting curve obtained prior to calculating the normalized melting curve. The derivative of the raw melting curve can be calculated by using the SG filter. In one embodiment of the present invention, the derivative of the normalized melting curve is calculated by taking a first derivative of the equation defining a mathematical relationship between the normalized melting curve and the raw melting curve.

According to another aspect of the present invention, a system for nucleic acid melting analysis is provided. The system comprises a biochip having at least one nucleic acid sample. A thermal generating apparatus is configured to ramp a temperature of the at least one sample to cause dissociation of the nucleic acids. Furthermore, an image detector is provided to acquire a plurality of images based on a fluorescence signal emitted by the nucleic acids during dissociation.

An image processing system is provided in communication with the thermal generating apparatus and the image detector. The image processing system includes memory having instructions for generating a raw nucleic acid melting curve based on the acquired images. Furthermore, the memory comprises instructions for calculating a normalized melting curve based on a mathematical equation defining a relationship between the normalized curve and the raw melting curve. A derivative of the normalized melting curve is calculated based upon the equation and a derivative of the raw melting curve obtained prior to calculating the normalized melting curve. The derivative of the raw melting curve can be calculated by using the SG filter. In one embodiment of the present invention, the derivative of the normalized melting curve is calculated by taking a first derivative of the equation defining a mathematical relationship between the normalized melting curve and the raw melting curve.

In one non-limiting embodiment, the at least one nucleic acid sample is located in one or more microchannels of the biochip.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements. Additionally, the left-most digit(s) of a reference number identifies the drawing in which the reference number first appears.

FIG. 1 is a functional block diagram of a genomic analysis system according to the present invention.

FIG. 2 is a melt analysis flow diagram representing the state of art.

FIG. 3 is a block diagram representing modifications to the “Normalization” block of FIG. 2 according to one embodiment of the present invention.

FIG. 4A is a graph representing a fluorescence curve before normalization.

FIG. 4B is a graph representing the fluorescence curve of FIG. 4A after normalization.

FIG. 5 is a flow diagram representing the melt analysis UI according to a first embodiment of the present invention.

FIG. 6 is a block diagram representing resample and cluster process according to the state of art.

FIG. 7 is a block diagram representing resample and cluster process according to one embodiment of the present invention.

FIG. 8 is a flow diagram representing the melt analysis UI according to a second embodiment of the present invention.

FIG. 9 is a block diagram illustrating an image processing system according to the present invention.

### DETAILED DESCRIPTION OF THE INVENTION

The present invention has several embodiments and relies on patents, patent applications, and other references for details known in the art. Therefore, when a patent, patent application, or other reference is cited or repeated herein, it should be understood that it is incorporated by reference in its entirety for all purposes as well as for the proposition that is recited.

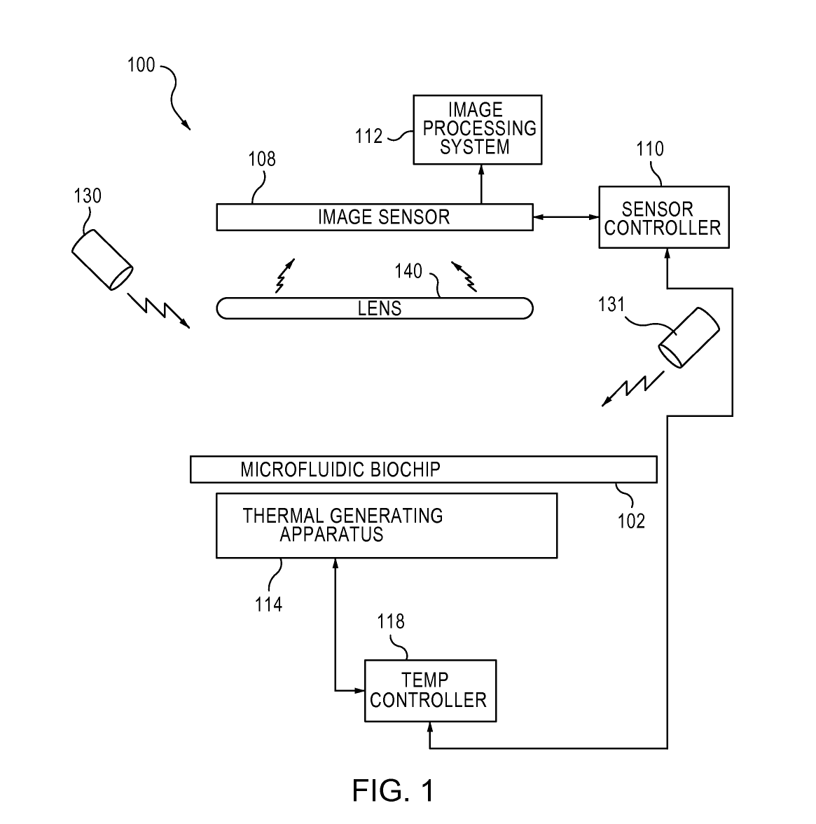

Referring to the drawings, FIG. 1 illustrates a nucleic acid analysis system 100 according to one embodiment of the present invention. As shown in FIG. 1, system 100 includes a biochip 102 where amplification reactions and a High Resolution Thermal Melt (HRTₘ) analysis are performed. In one embodiment, the biochip 102 is a microfluidic biochip. Biochip 102 includes a number of parallel microfluidic channels where amplification reactions and melting analysis may be performed in parallel. It is contemplated that biochip 102 may have any number of channels having nucleic acid samples. In yet another embodiment, the biochip 202 is not limited to having multiple parallel channels and may include any number of channels, wells, and/or chambers provided in a variety of different configurations. Channels, wells, and/or chambers may contain at least one nucleic acid sample that may be stationary or move within the biochip 202 during an amplification reaction and melting analysis.

In some embodiments, when system 100 is in use, each channel 202 receives a sample (or “bolus”) of a solution containing real-time PCR reagents. A force may be used to cause the bolus to travel through the channel such that the bolus undergoes a PCR reaction and subsequent HRTₘ analysis.

Genomic analysis system 100 further includes an image sensor 108, a controller 110 for controlling image sensor 108, and an image processing system 112 for processing images acquired by image sensor 108. Image sensor 108 may be implemented using a CMOS image sensor, a CCD image sensor, or other image sensor. In one non-limiting embodiment, the image processing system 112 processes a plurality of images acquired during HRTₘ to simultaneously monitor dissociation behavior of different DNA samples in different microfluidic channels.

As further illustrated in FIG. 1, system 100 may include one or more thermal generating apparatuses 114 and a controller 118 for controlling apparatuses 114. The thermal generating apparatus 114 is configured to provide a substantially steadily increasing amount of heat to cause the bolus to undergo HRTₘ(i.e., to cause the dsDNA in the bolus to transition to ssDNA). In one example, thermal generating apparatus 114 may provide a thermal ramp rate of typically 0.1 to 2 degree Celsius (C.) per second, with the preferred ramp rate being between 0.5 and 1 degree Celsius (C.) per second.

Referring now to sensor controller 110, sensor controller 110 may be configured so that, for each bolus that undergoes HTRm, image sensor controller 110 causes sensor 108 to capture images while the bolus undergoes the nucleic acid dissociation process. In one non-limiting embodiment, at least about 10 images per second for at least about 1 minute are acquired while the bolus undergoes the nucleic acid dissociation process. In embodiments where the ramp rate is faster, the image sensor controller 110 may cause sensor 108 to capture the images at a rate of about 20 images per second. In many embodiments, the goal is to achieve a temperature resolution of 0.1 degree Celsius or better.

In some embodiments, system 100 may further include an excitation source 131 (e.g., a laser or other excitation source) for illuminating microfluidic channels of biochip 102. System 100 may further include a lens 140 that is disposed between chip 102 and image sensor 108. Accordingly, image sensor 108 provides a series of images for each channel of biochip 102 to the image processing system 112 while nucleic acids in the channels undergo a dissociation reaction. For each microfluidic channel, the plurality of images acquired during nucleic acid dissociation is presented in the form a fluorescence curve. The fluorescence (melting) curve represents fluorescence intensity emitted by nucleic acids as a function of temperature as the temperature is increasing at a steady rate. As the temperature is raised, the double strand begins to dissociate leading to a change in fluorescence intensity. High resolution thermal melting analysis and associated microfluidic systems have been described in U.S. Pat. No. 8,778,637 to Knight at al., U.S. Pat. No. 8,606,529 to Boles at al., and U.S. Pat. No. 8,483,972 to Kanderian the disclosures of which are hereby incorporated by reference.

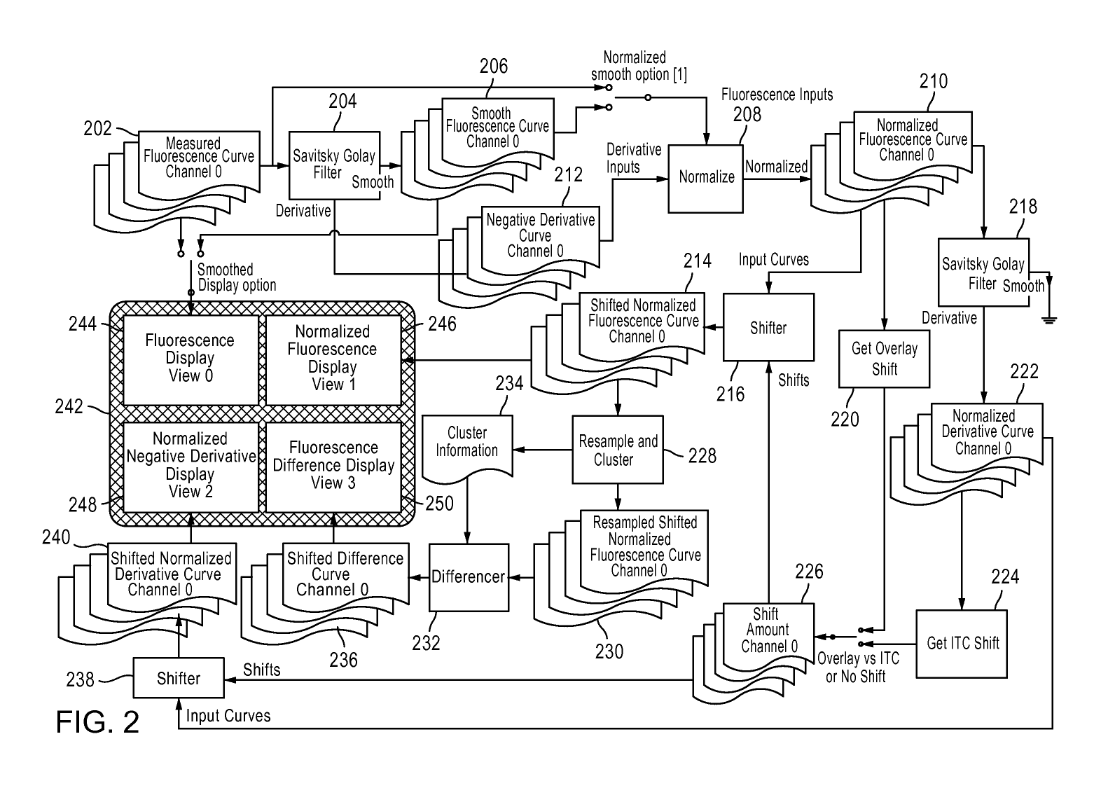

FIG. 2 is a flow diagram demonstrating a state of the art method for analysis of fluorescence curves obtained as a result of nucleic acid dissociation by the image processing system 112 shown in FIG. 1. The fluorescence curves are measured in parallel microfluidic channels of biochip 102, one fluorescence curve for each channel. Raw fluorescence curves 202 (one curve for each microfluidic channel) may be presented to the user through a graphical user interface (GUI) 242, fluorescence display 244. Alternatively, the measured fluorescence curves 202 may undergo a smoothing process prior to being presented in the fluorescence display 244.

In one embodiment, each of the measured fluorescence curves 202 is smoothed using the SG filter, box 204. Specifically, to smooth a fluorescence curve 202, the SG filter creates an approximating function that attempts to capture important patterns in the curve data, while leaving out noise. Additionally, a negative derivative curve 212 may be calculated for each measured fluorescence curve 202 by using the SG filter, box 204. Next, the smoothed fluorescence curves 206 and negative derivative curves 212 are received at the “Normalization” box 208. Alternatively, raw fluorescence curves 202 can be passed for normalization to the “Normalization” box 208.

In one non-limiting embodiment, normalization methods used for normalization of the smoothed fluorescence curves 206 include a baseline method, a homogeneous method, an inhomogeneous method type I, an inhomogeneous method type II, and a rescale method. Each of these normalization methods can be used for melting analysis and will be discussed in greater detail below. The normalized fluorescence curves 210 are processed by the SG filter, box 218, to obtain normalized derivative curves 222.

As temperatures measured for each of the parallel channels of biochip 202 may have a bias, the bias needs to be removed by shifting the temperature on the normalized fluorescence curves 210. To remove the bias, an internal temperature control (ITC) shift method and an overlay shift method may be used for temperature shifting.

The ITC shift method is based upon an independent control characterized by a known melting temperature that is included in an amplicon melting reaction. The known melting temperature of the independent control should be outside the range of the amplicon melting temperature. The difference between the known and measured melting temperature of the independent control is then estimated for each channel and differences between the channels are used to adjust the temperatures. In some embodiments, the true melting temperature may be estimated by averaging the measured ITC melting temperatures and the differences of each channel to the mean are used to adjust temperature. Returning to FIG. 2, an ITC shift is calculated for the normalized derivative curves 222, box 224.

The overlay shift method used for shifting the curves is based on the assumption that the fluorescence curves from the various channels have the same average temperature at some small fluorescence range. Thus, all of the fluorescence curves have some approximate common crossing point. In FIG. 2, an overlay shift is calculated for the normalized fluorescence curves 210, box 224.

A temperature shift 226 may be calculated for each channel using either the ITC shift method or the overlay shift method. A shifter 238 shifts each of the normalized derivatives curves 222 using a the corresponding shift 226. The shifted normalized derivative curves 240 are presented to the user through the GUI 242, normalized negative display 248.

Similarly, each of the normalized fluorescence curves 210 is shifted by a shifter 216 using a corresponding shift 226. Next, the shifted normalized curves 214 are presented to the user through the GUI 242, normalized fluorescence display 246.

In one embodiment, the shifted normalized curves 214 are passed to a “Resample and Cluster” box 228. The temperatures of the high resolution melt are sampled from the system 100 as the temperature is ramped. Both the temperature estimated from the thermal generating apparatus 114 and the fluorescence obtained from an image sensor 108 of the channel are measured repeatedly. As the temperature may vary slightly between the channels, for each fluorescence curve the fluorescence samples are collected at different temperatures. When results from one channel to another or from one fluorescence curve to another need to be compared, a common temperature scale is used. Using a common temperature scale means that the fluorescence (or the derivative) is estimated on a regular temperature grid covering the intersection of the curves' temperature ranges. The fluorescence curves from each channel are interpolated at each temperature on this common grid (common temperature scale). Once the curves are “resampled” (or interpolated) at the same temperatures, differences between each fluorescence curve (smooth or not smooth) and a reference curve can be taken and the curves can be clustered. The reference curve is typically based on one of the fluoresce curves, an average of more than one reference curve, a previously measured curve, a theoretically generated curve, or a cluster centroid (which could be an average of one or more reference curves).

In one embodiment, the resampled shifted normalized fluorescence curves 230 are passed to a differencer 232 together with cluster information 234 to obtain shifted difference curves 236. Each shifted difference curve 236 represents a difference between a normalized fluorescence curve 230 and a reference curve. The shifted difference curves are presented to the user through the GUI 242, fluorescence difference display 250.

In FIG. 2, boxes 204, 218, and 228 (“Resample and Cluster”) use the SG filter for each channel of data or each fluorescence curve being processed. Of all the boxes, the boxes 204, 218, and 228 are by far the most expensive in terms of computation time.

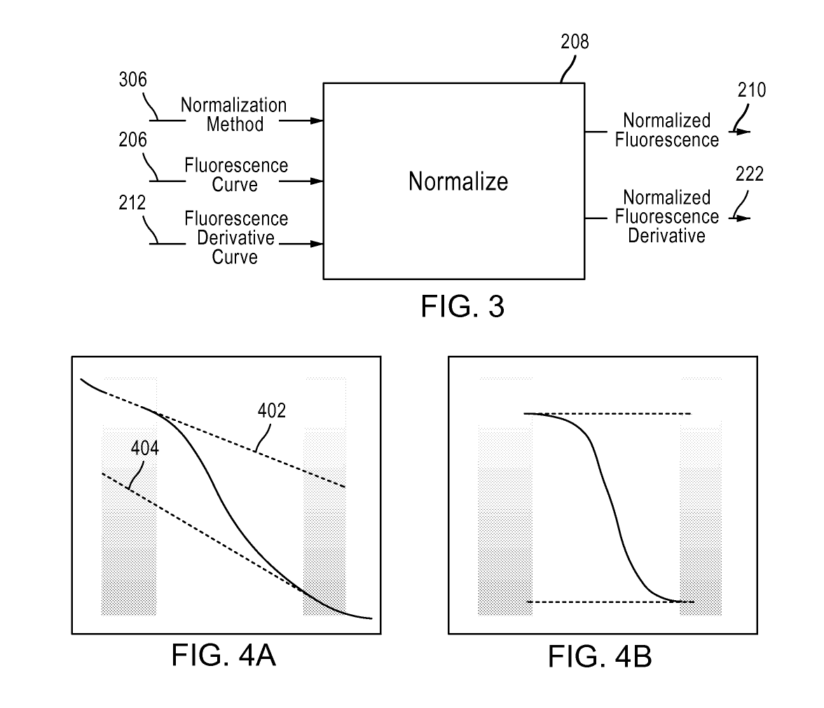

According to the present invention, the “Normalize” box 208 is used to eliminate the SG filter 218 by computing normalized derivatives within the “Normalize” box 208 as shown in FIG. 3. FIGS. 3-8 illustrate embodiments according to the present invention directed to eliminating the usage of the SG filter 218.

FIG. 3 represents the “Normalization” box 208 shown in FIG. 2. In one embodiment of the present invention, inputs to the “Normalization” box 208 include normalization method 306, smoothed fluorescence curves 206, and negative fluorescence derivative curves 212. Normalized fluorescence curves 210 and normalized fluorescence derivative curves 222 are the outputs provided by the “Normalization” box 208. In one non-limiting embodiment, normalization method 306 used by the “Normalization” box 208 can be selected by the user.

In one embodiment of the present invention, the “Normalization” box 208 can be used not only to normalize the smoothed fluorescence curves 206, but also to produce normalized derivatives 222 for the smoothed fluorescence curves 206 without using the SG filter 218. How each of the known normalization methods can be applied to produce the normalized derivatives 222 without using the SG filter, will be explained in greater details below.

For the purposes of clarity, the details on the processing are described below for one sample. It should be appreciated that these methods may be extended to the processing of multiple samples.

Let T be the variable that is used to denote temperature. Let F(T) be the input fluorescence curve 206 to the “Normalization” box 208. As can be seen from FIGS. 2-4, the input of the “Normalization box” 208 can be either a smoothed curve 206 coming from the first SG filter 204, or it can be the actual raw fluorescence data.

F′(T) is used to denote the input fluorescence derivative 212 which may be generated from the first SG filter 204 derivative output. S(T) denotes the normalized fluorescence signal 210. The derivative of the normalized fluorescence is denoted as S′(T). A background fluorescence signal is denoted as B(T). Normalization methods that are discussed in greater detail below seek to identify and remove the background signal B(T). According to one embodiment of the present invention, the derivative of a normalized fluorescence curve 222, hereinafter denoted as S′(T), can be calculated by using a negative derivative curve 212 provided by the first SG filter 204 and without using the second SG filter 218.

In one embodiment, a low and high temperature can be defined by the user through the modification of cursors on the Fluorescence Display View 244. In one embodiment, the low and high temperatures T_{L} and T_{H} are average temperatures in a low interval and high interval. In yet another embodiment, only the low or high temperatures or temperature intervals are used. The input fluorescence and the fluorescence derivative curves are calculated at these low and high temperatures. The exact estimation of F(T_{L}), F(T_{H}), F′(T_{L}), and F′(T_{H}) are often method dependent.

Baseline Normalization Method

FIG. 4A shows a pre-normalized fluorescence curve with two linear fits represented by dashed lines 402 and 404. The dashed lines 402 and 404 are fit to the lower and higher temperature regions (shaded areas). FIG. 4B shows the curve of FIG. 4A normalized by the baseline method. The baseline method fits the lower and higher temperature regions to two respective linear curves. The normalized signal falls between these two linear fits 402 and 404 as shown in FIG. 4B.

The baseline normalized fluorescence is given by the expression:

$$S ( T ) = 100 \frac{F ( T ) - {P}_{H} ( T )}{{P}_{H} ( T ) - {P}_{L} ( T )} , \qquad ( 1 )$$

where P_{L}(T) and P_{H}(T) are the linear fits 402 and 404 of the lower and higher temperature regions, respectively. In one embodiment, P_{L}(T) and P_{H}(T) are defined by the user. The expressions for the linear fits 402 and 404 are:

P_{L}(T)=F′(T_{L})(T−T_{L})+F(T_{L}) (2)

P_{H}(T)=F′(T_{H})(T−T_{H})+F(T_{H}) (3)

In the above expressions, F′(T_{L}) and F′(T_{H}) are defined as the average fluorescence derivative value in the respective shaded regions. T_{L} and T_{H} are defined as the average temperatures in the respective shaded regions.

As shown in FIG. 2 illustrating the state of art approach, the normalized fluorescence curves 206, S(T), are passed to the SG filter 218 and the derivative output 222 of the SG filter 218 is used. According to one embodiment of the present invention, the SG filter 218 can be eliminated as the normalized derivative curve 222 is obtained by differentiating equation (1) using a negative derivative curve 212 provided by the first SG filter 204:

$${S}^{′} ( T ) = 100 \frac{{F}^{′} ( T ) - {P}_{H}^{′} ( T )}{{P}_{H} ( T ) - {P}_{L} ( T )} - 100 \frac{[ F ( T ) - {P}_{H} ( T ) ] [ {P}_{{H}^{′}} ( T ) - {P}_{{L}^{′}} ( T ) ]}{{[ {P}_{H} ( T ) - {P}_{L} ( T ) ]}^{2}} , \qquad ( 4 )$$

where P_{L}′(T) and P_{H}′(T) are derived from equations (2) and (3) respectively:

P_{L}′(T)=F′(T_{L}) (5)

P_{H}′(T)=F′(T_{H}) (6)

Equation (4) can be written in terms of the inputs F(T) and F′(T) as well as the already calculated terms of the normalization method, F′(T_{L}), F′(T_{H}), P_{L}(T), and P_{H}(T):

$${S}^{′} ( T ) = 100 \frac{{F}^{′} ( T ) - {F}^{′} ( {T}_{H} )}{{P}_{H} ( T ) - {P}_{L} ( T )} - S ( T ) \frac{{F}^{′} ( {T}_{H} ) - {F}^{′} ( {T}_{L} )}{{P}_{H} ( T ) - {P}_{L} ( T )} \qquad ( 7 )$$

Accordingly, the second SG filter 218 used for calculating a normalized derivative curve 222 as shown in FIG. 2 is not required for implementation of the present invention as the normalized derivative curve 222 is calculated during normalization process based upon the derivative curve 212 calculated by the first SG filter 204 for a pre-normalized fluorescence curve and a mathematical model defining the baseline normalization method. According to equation (7), the normalized fluorescence derivative 222 can be calculated at each temperature sample with the additional cost of about six floating point operations. In comparison, the SG filter may cost typically on the order of hundreds or thousands of operations per temperature sample.

### Homogeneous Normalization Method

The homogeneous normalization method is based on the assumption that the observed fluorescence curve can be represented as a normalized curve plus a background fluorescence curve. Furthermore in this method, the background curve is assumed to be an inverse exponential and the signal is around zero in the low and higher temperature regions.

Thus, according to the homogeneous normalization method each measured fluorescence curve 202 or each smoothed fluorescence curve 206 can be represented as a sum of a normalized curve S(T) and a background curve B(T):

F(T)=S(T)+B(T), where (8)

B′(T)=−rB(T)

S′(T_{L})=S′(T_{H})≈0 (9)

From the derivative of equation (8) and the zero slope signal in the low and high regions

B′(T_{L})≈F′(T_{L})

B′(T_{H})≈F′(T_{H}) (10)

The solution of the background differential equation in equation (9) is a constant times the inverse exponential which may take the form:

B(T)=b_{L}e^{-r(T-T}^{_{L}}⁾ (11)

The background derivative can be calculated from equation (11) and evaluated at T_{L} and T_{H}.

B′(T)=−rb_{L}e^{-r(T-T}^{_{L}}⁾

B′(T_{L})=−rb_{L}=F′(T_{L}) (12)

B′(T_{H})=−rb_{L}e^{-r(T}^{_{H}}^{-T}^{_{L}}⁾=F′(T_{H})

Using the two equations above and solving for the two unknowns b_{L} and r

$$r = \frac{ln [ {F}^{′} ( {T}_{H} ) ] - ln [ {F}^{′} ( {T}_{L} ) ]}{{T}_{H} - {T}_{L}} \\ {b}_{L} = \frac{{F}^{′} ( {T}_{L} )}{r} \qquad ( 13 )$$

Equation (8) leads to a simple expression of the normalized derivative S′(T):

S′(T)=F′(T)−B′(T) (14)

This equation may be written in terms of the input negative derivative curve F′(T), the already calculated background B(T), and the already estimated parameter r:

S′(T)=F′(T)+rB(T) (15)

Accordingly, the second SG filter 218 used for calculating a normalized derivative curve 222 as shown in FIG. 2 is not required for implementation of the present invention as the normalized derivative curve 222 is calculated during normalization process based upon the derivative curve 212 calculated by the first SG filter 204 for a pre-normalized fluorescence curve and a mathematical model defining the homogeneous normalization method. Equation (15) shows that with two additional floating point operations per temperature sample the normalized fluorescence derivative can be calculated simultaneously with the normalized fluorescence.

### Inhomogeneous (Type I) Normalization Method

The first inhomogeneous normalization method starts with the differential equation:

F′(T)=S′(T)+B′(T) (16)

The method also assumes that:

B′(T)=−k F(T) and (17)

S′(T_{L})≈0 (18)

According to equations (17) and (18):

$${B}^{′} ( {T}_{L} ) = {F}^{′} ( {T}_{L} ) \\ {F}^{′} ( {T}_{L} ) = - kF ( {T}_{L} ) \\ k = - \frac{{F}^{′} ( {T}_{L} )}{F ( {T}_{L} )} \qquad ( 19 )$$

The inhomogeneous normalization methods (both type I and type II), actually calculate the normalized fluorescence derivative S′(T) and then numerically integrate S′(T) in order to estimate S(T). This implies that the method internally already calculates the normalized derivative 222 and thus requires no additional calculations.

### Inhomogeneous (Type II) Normalization Method

The type II inhomogeneous normalization uses equation (16) and an affine model on the background derivative according to the following equation:

B′(T)=−k₁F(T)+k₂ (20)

In addition, the method uses the following constraints:

S′(T_{L})≈0

S′(T_{H})≈0 (21)

Based on equations (16), (20), and (21):

F′(T_{L})=−k₁F(T_{L})+k₂

F′(T_{H})=−k₁F(T_{H})+k₂ (22)

Accordingly, k₁ and k₂ can be calculated as:

$${k}_{1} = - \frac{{F}^{′} ( {T}_{L} ) - {F}^{′} ( {T}_{H} )}{F ( {T}_{L} ) - F ( {T}_{H} )} \\ {k}_{2} = - \frac{{F}^{′} ( {T}_{L} ) F ( {T}_{H} ) - {F}^{′} ( {T}_{H} ) F ( {T}_{L} )}{F ( {T}_{L} ) - F ( {T}_{H} )} \qquad ( 23 )$$

Similarly to inhomogeneous type I normalization, the solution for the normalized signal is found by integrating the normalized derivative. Thus there is no additional calculation needed to produce the normalized fluorescence derivative 222. Accordingly, the second SG filter 218 used for calculating a normalized derivative curve 222 as shown in FIG. 2 is not required for implementation of the present invention as the normalized derivative curve 222 is calculated during normalization process based upon the derivative curve 212 calculated by the first SG filter 204 for a pre-normalized fluorescence curve and a mathematical model defining the inhomogeneous normalization method (type I and type II).

### Rescale and None Normalization Methods

The rescale method does not remove a background signal. The normalization simply scales the input fluorescence signal in some way. Typically, it will rescale the minimum and maximum values so that the resulting normalization curve falls between 0 and 100 within some user defined temperature range.

Thus, the normalization model is:

S(T)=αF(T)+β, (24)

where α and β are typically

$$α = \frac{100}{{max}_{T} F ( T ) - {min}_{T} F ( T )} \\ β = - \frac{100 [ {min}_{T} F ( T ) ]}{{max}_{T} F ( T ) - {min}_{T} F ( T )} \qquad ( 25 )$$

In the “None” normalization method α=1 and β=0. The normalized fluorescence derivative can be found by differentiating equation (24).

S′(T)=αF′(T) (26)

Thus, in the “None” method the normalized fluorescence derivative 222 is simply the input fluorescence derivative 212. In the rescale normalization method, the input fluorescence derivative is scaled by the already calculated value a.

Typically, all of the normalization methods also rescale the normalized fluorescence result to the range zero to 100. This rescaling can be applied by rescaling the result with the rescale method after the prescribed normalization method has been carried out. Specifically, the rescale factor α not only applies to the normalized fluorescence but also to the normalized fluorescence derivative. Thus, one process is to first calculate the normalized fluorescence scale factors and then rescale the normalized fluorescence (with α and β) and apply a scaling of α to the normalized fluorescence derivative.

All normalization methods as presented above can be used to calculate normalized derivative curve 222. The second SG filter 218 used for calculating a normalized derivative curve 222 as shown in FIG. 2 is not required for implementation of the present invention as the normalized derivative curve 222 is calculated during normalization process based upon the derivative curve 212 calculated by the first SG filter 204 for a pre-normalized fluorescence curve and a mathematical model defining selected normalization method.

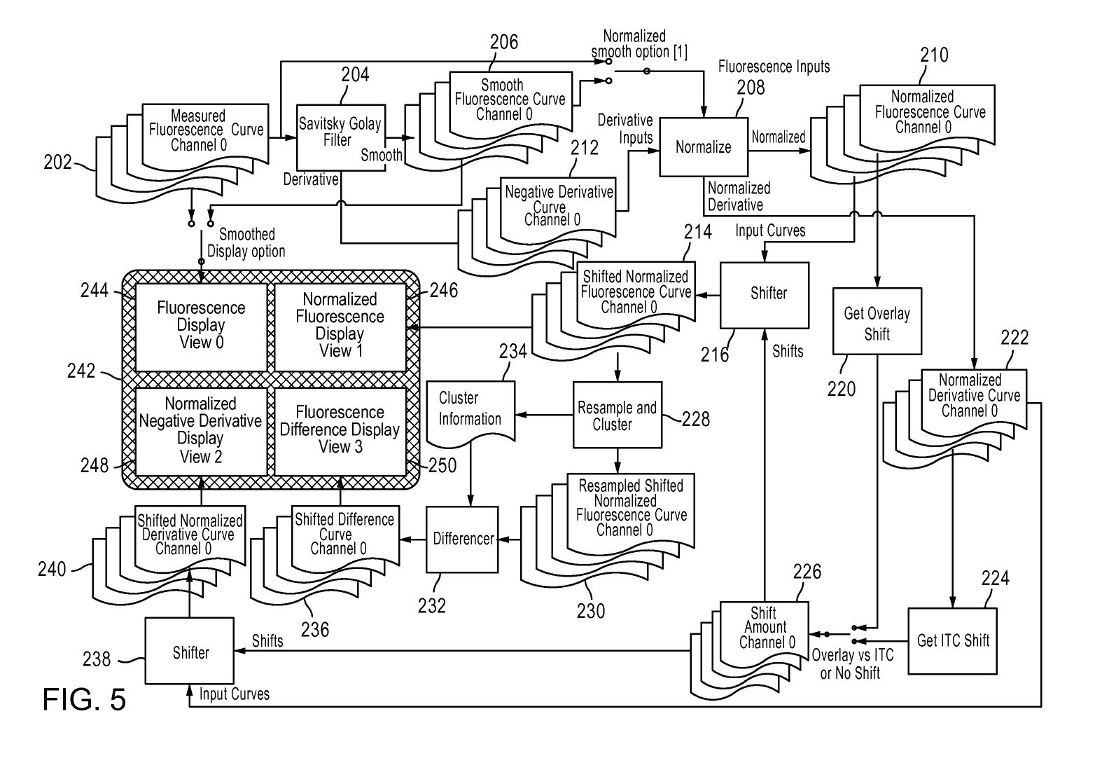

FIG. 5 is a flow diagram representing a melt analysis UI that is a modification of the melt analysis UI represented in FIG. 2. Specifically, FIG. 5 includes a “Normalization” box 208 according to one embodiment of the present invention demonstrated in FIG. 3. In contrast to FIG. 2, FIG. 5 does not include the SG filter 218 to calculate the normalized fluorescence derivative 222. Rather, the normalized fluorescence derivative 222 is calculated at the “Normalization” box 208 by using an equation according to a selected normalization method defining a mathematical relationship between the normalized derivative 222 and the pre-normalized derivative 212. The pre-normalized fluorescence derivative 212 is calculated by the first SG filter 204 based on the pre-normalized (raw or smoothed) fluorescence curve 202.

In one embodiment, equations (4), (15), (16-19), (16, 22, 23) and (26) may be used to calculate the normalized derivative 222 based on the derivative of the pre-normalized fluorescence curve 202. Each of the equations (4), (15), (16-19), (16, 22, 23) and (26) is based on a selected normalization method defining a mathematical relationship between a normalized fluorescence curve and a raw fluorescence curve. Specifically, equation (4) corresponds to baseline normalization method, equation (15) corresponds to homogeneous normalization method, equations (16-19) corresponds to inhomogeneous type I normalization method, equations (16, 22, 23) correspond to inhomogeneous type II, and equation (26) corresponds to rescale normalization method, each of these methods discussed above in great details.

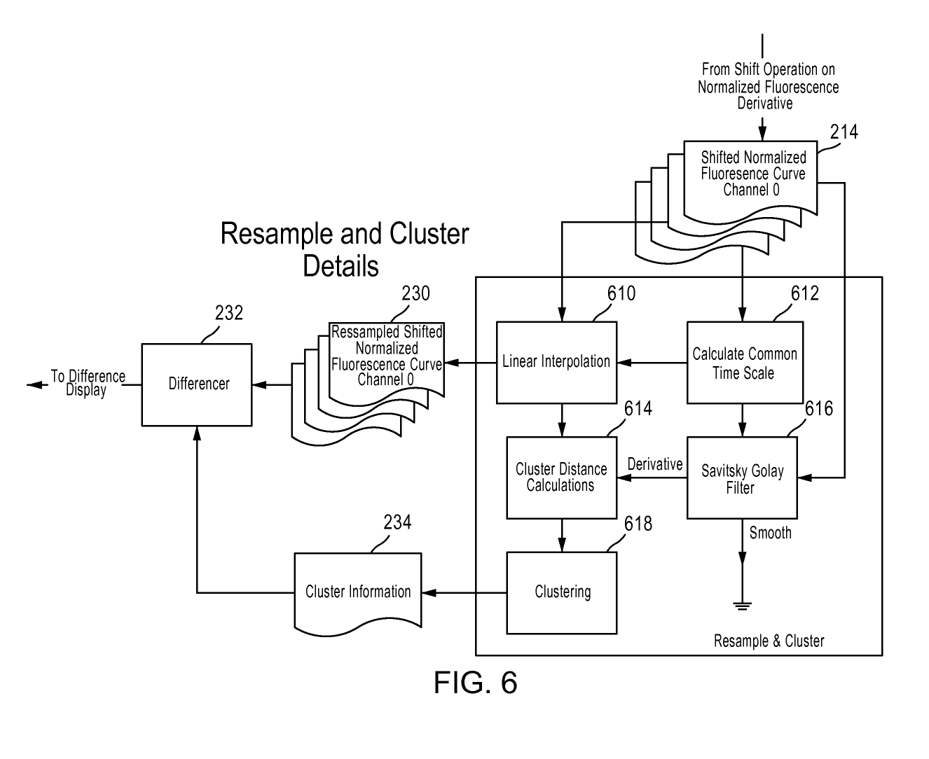

The “Resample and Cluster” box 228 shown in FIGS. 2 and 5 is demonstrated in greater details in FIG. 6. The “Resample and Cluster” box 228 includes an SG filter 616 which is a costly operation in terms of computation time. The shifted normalized fluorescence curves 214 (FIGS. 2 and 5) are received at the “Resample and Cluster” box 228 to calculate a common temperature scale, box 612. Next, the SG filter 616 is used to estimate derivatives of the shifted normalized fluorescence curves 214 on the common temperature scale calculated at box 612. These derivatives may be used in the curve-to-curve distance calculations, box 614. Specifically, the cluster distance calculations 614 determine how close one cluster is to another cluster. In one embodiment, cluster distance measures may require a single calculation of all pairwise curve distances. In this case, the distance between two clusters is the nearest distance between all pairs of curves where the first curve is selected from the first cluster and the second curve is selected from the second cluster. In yet another embodiment, the cluster distance is computed as the average distance between all pairs between the two clusters. After the cluster distance calculations 614 are completed, clustering process is performed at box 618.

Parallel to calculating the common temperature scale 612, the shifted normalized curves 214 are passed to a “Linear Interpolation” box 610. Resampled shifted normalized fluorescence curves 230 are calculated by using linear interpolation and the common temperature scale 612.

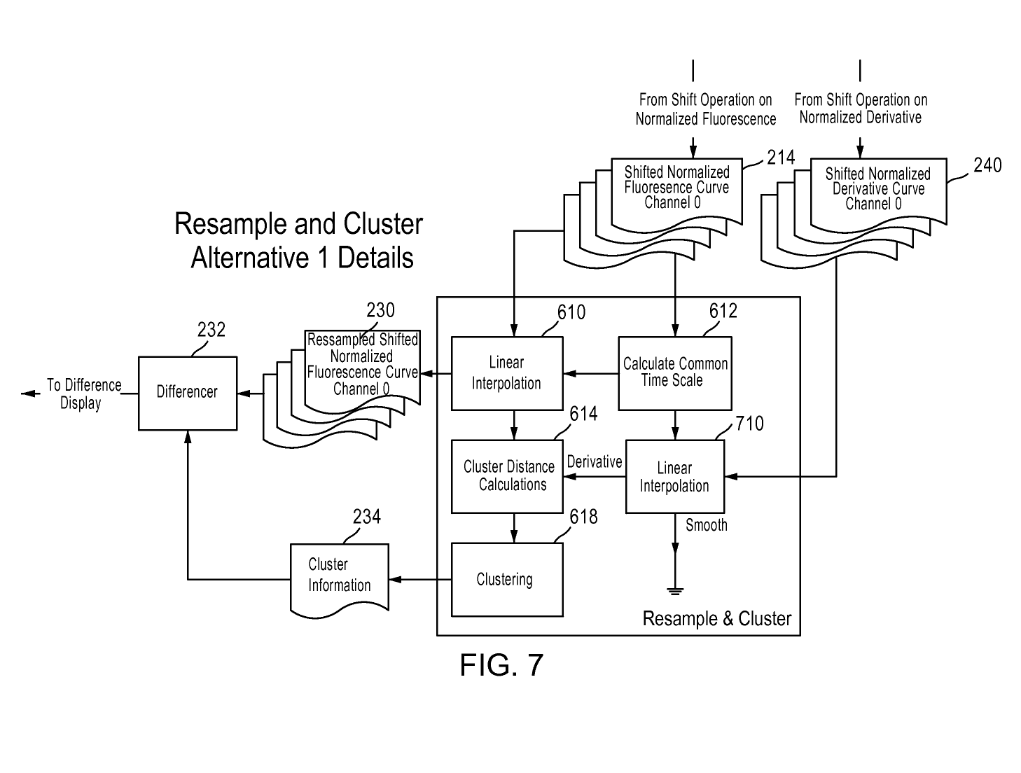

As the SG filter 616 demonstrated in FIG. 6 presents a bottle neck in terms of computation time, FIG. 7 provides modifications to the process according to FIG. 6 directed to decreasing computation time associated with the “Resample and Cluster” box 228. FIG. 7 is a flow diagram according to one embodiment of the present invention that eliminates the usage of the SG filter 616 in the “Resample and Cluster” box 228. Specifically, the shifted normalized fluorescence curves 214 are processed to calculate the common temperature scale 612. Next, the common temperature scale 612 and the shifted normalized derivative curves 240 calculated at the “Normalization box” 208 are passed to a “Liner Interpolation” box 710 to estimate the derivative of the shifted normalized fluorescence curve 214 on the common temperature scale 612. This derivative may be used in the curve-to-curve distance calculations, box 614, that are subsequently employed for clustering at box 618.

Once the shifted normalized curves 214 are provided at the “Linear Interpolation” box 610 together with the calculated common temperature scale 612, resampled shifted normalized fluorescence curves 230 are calculated by using linear interpolation and the common temperature scale 612.

Calculating the derivative of the shifted normalized fluorescence derivative 240 at the common temperature scale 612 by using linear interpolation is more efficient in terms of computation time. This approach in many circumstances may be sufficient to provide the needed information for the cluster distance calculations 614. The purpose of using the derivative in the distance calculations is to discount errors in areas of rapid curve slope changes. In one embodiment, the distance calculations 614 can be modified such that they do not require a derivative.

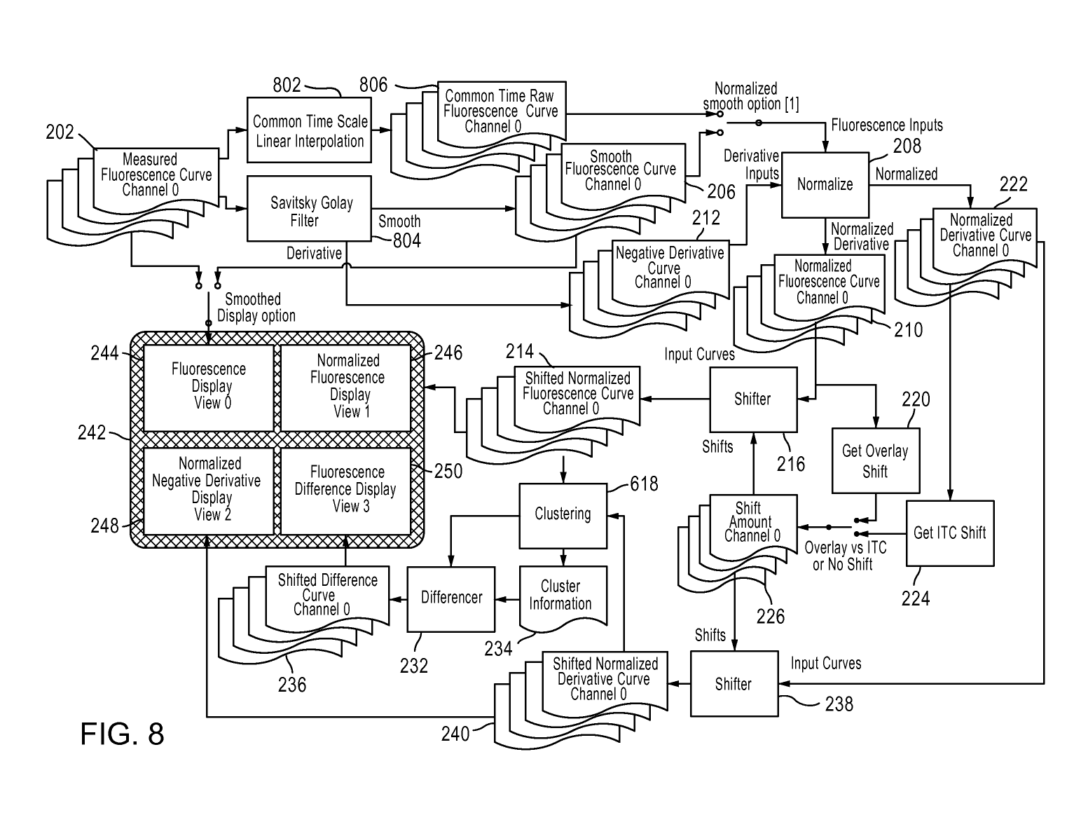

FIG. 8 is a flow diagram representing a melt analysis UI according to another embodiment of the present invention. FIG. 8 is different from FIG. 5 in that the change to a common temperature scale is performed at the first application of an SG filter 804. Alternatively, the measured fluorescence curves 202 are resampled on a common temperature scale by using linear interpolation, box 802. Accordingly, measured fluorescence curves 806 or smoothed fluorescence curves 206 resampled on a common temperature scale can be used as an input for the “Normalization” box 208. This approach would eliminate the resample process 228 used in FIG. 2 and FIG. 5. According to FIG. 8, the “Resample and Cluster” box 228 shown in FIGS. 2 and 5 is reduced to the “Clustering” box 618 as the resampling process presented in FIGS. 6 and 7 is performed at boxes 802 and 804.

In one embodiment of the present invention, the SG filtering as well as other steps are implemented in parallel for all channels. When processing multiple channels the most practical method for parallel implementation of the SG filters is to run each channel filter in an independent threaded task. In one embodiment on a quad core processor, an improvement in processing time was by a factor of three. In other embodiments, the speed up in filtering can be achieved by breaking a single curve into multiple pieces. In addition, processing speed of the filter can be improved by reusing the intermediate results from the previous window, because as the filter window moves along the curve from one point to the next, the next window will contain mostly the same points (with the exception of those entering the window and those leaving the window). In one embodiment, QR matrix factorization is used to solve the least squares polynomial fit in the window of the SG filter. QR matrix factorization decomposes a matrix into an orthogonal matrix Q times a upper triangular matrix R. This factorization can be used to solve linear equations. In this approach successive QR updates may be used as the window is moved. Such an approach may change the computational complexity by a factor of the order of the polynomial used for fitting.

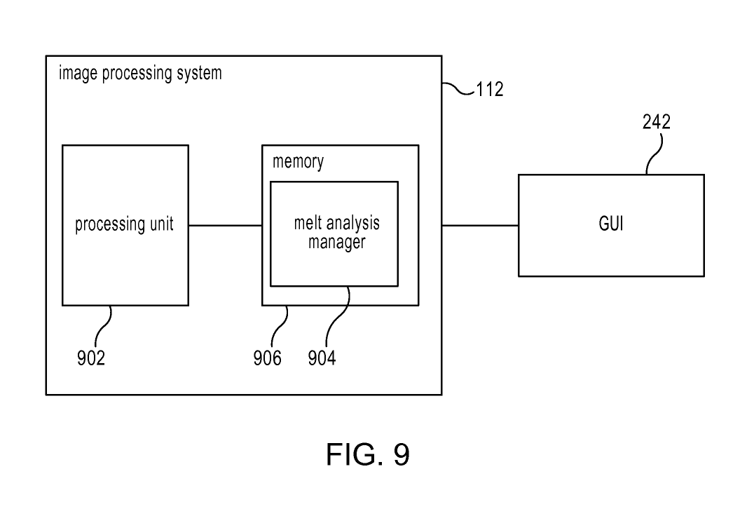

FIG. 9 is a block diagram illustrating an image processing system 112 as shown in FIG. 1 according to the present invention. Specifically, the image processing system 112 includes a processing unit 902 in communication with memory 904. Memory 904 contains a melt analysis manager 906 including instructions according to melt analysis flow diagrams presented in FIGS. 2 and 5-8. The instructions according to FIGS. 2 and 5-8 are executed by the processing unit 902 and presented to the user through GUI 242 shown in FIGS. 2, 5, and 8. In one embodiment, the user can alternatively select flow diagrams demonstrated in FIGS. 2, 5, and 8 and FIGS. 6 and 7 and a combination thereof for execution by the processing unit 902 through the GUI 242. Raw fluorescence curves 244, normalized fluorescence curves 246, normalized negative derivative 248, and fluorescence difference 250 are provided to the user through the GUI 242. In yet another embodiment, the user can select a plurality of parameters associated with processes according to the flow diagrams demonstrated in FIGS. 2 and 5-8.

The melt analysis manager 904 comprises instructions provided to the processing unit 902 to perform melting analysis of nucleic acids associated with samples integrated into the biochip 102. Specifically, the melt analysis manager 904 uses data acquired in conjunction with the system 100 demonstrated in FIG. 1. The thermal generating apparatus 114 is employed to ramp the temperature in at least one sample on the biochip 102 to cause dissociation of nucleic acids. The image sensor 108 acquires a plurality of images for each sample based on a fluorescence signal emitted by the nucleic acids during dissociation. The processing unit 902 generates a raw nucleic acid melting curve for each sample based on the acquired images and processes the generated melting curves according to instruction as presented in flow diagrams of FIGS. 2 and 5-8. The results of melting analysis are presented to the user through the GUI 242. Accordingly, the melt analysis manager 904 comprises instructions that are processed by the processing unit 902 in conjunction with data acquired and controlled by the system demonstrated in FIG. 1.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. A method for performing melting analysis, the method comprising:
ramping a temperature in at least one sample to cause dissociation of nucleic acids in the at least one sample on a biochip;
for each sample, acquiring a plurality of images based on a fluorescence signal emitted by the nucleic acids during dissociation;
for each sample, generating a raw nucleic acid melting curve based on the acquired images, the raw melting curve representing the fluorescence signal emitted by the nucleic acids as a function of the temperature;
providing an equation defining a mathematical relationship between a normalized melting curve and the raw melting curve;
calculating the normalized melting curve based on the equation; and
calculating a derivative of the normalized melting curve based on the equation and a derivative of the raw melting curve obtained prior to calculating the normalized melting curve.

2. The method of claim 1, wherein the step of calculating a derivative of the normalized melting curve includes taking a first derivative of the equation defining a mathematical relationship between the normalized melting curve and the raw melting curve.

3. The method of claim 1, wherein the mathematical equation defines the raw melting curve as a sum of the normalized melting curve and a background.

4. The method of claim 1, wherein the equation defining a mathematical relationship between the normalized melting curve and the raw melting curve is based upon a method selected from the group consisting of: baseline method, homogeneous method, inhomogeneous method type I, inhomogeneous method type II, and rescale method.

5. The method of claim 1, further comprising smoothing the raw melting curve and calculating a derivative of the smoothed melting curve by using a Savitzky-Golay filter prior to calculating the normalized melting curve.

6. The method of claim 1, wherein raw melting curves are simultaneously generated in two or more samples.

7. The method of claim 6, further comprising calculating a temperature bias between the at least two samples and generating shifted normalized melting curves and shifted normalized derivatives based on the temperature bias.

8. The method of claim 6, further comprising resampling the normalized melting curves corresponding to different samples on a common temperature scale.

9. The method of claim 6, further comprising resampling raw melting curves corresponding to different samples on a common temperature scale prior to calculating the normalized melting curves.

10. The method of claim 9, wherein resampling on a common temperature scale is performed by linear interpolation.

11. The method of claim 1, wherein the at least one sample is in at least one microchannel of the biochip.

12. The method of claim 11, wherein raw melting curves are simultaneously generated in two or more samples of the biochip.

13. The method of claim 11, wherein the normalized melting curves corresponding to different samples are resampled on a common temperature scale.

14. The method of claim 13, wherein raw melting curves corresponding to different samples are resampled on a common temperature scale prior to calculating the normalized melting curves.

15. A system for performing melting analysis, the system comprising:
A biochip including at least one sample having nucleic acids;
a thermal generating apparatus configured to ramp a temperature of the at least one sample to cause dissociation of the nucleic acids;
an image detector configured to acquire a plurality of images based on a fluorescence signal emitted by the nucleic acids during dissociation;
an image processing system in communication with the thermal generating apparatus and the image detector, the image processing system comprising a processor in communication with memory having instructions for:
generating a raw nucleic acid melting curve based on the acquired images, the raw melting curve representing a fluorescence signal emitted by the nucleic acids as a function of the temperature;
providing a mathematical equation defining a relationship between a normalized melting curve and the raw melting curve;
calculating the normalized melting curve based on the equation; and
calculating a derivative of the normalized melting curve based upon the equation and a derivative of the raw melting curve obtained prior to calculating the normalized melting curve.

16. The system of claim 15, wherein the equation defines the raw melting curve as a sum of the normalized melting curve and a background.

17. The system of claim 15, wherein calculating a derivative of the normalized melting curve includes taking a first derivative of the equation defining a mathematical relationship between the normalized melting curve and the raw melting curve.

18. The system of claim 15, wherein the equation defining a mathematical relationship between the normalized melting curve and the raw melting curve is based upon a method selected from the group consisting of: baseline method, homogeneous method, inhomogeneous method type I, inhomogeneous method type II, and rescale method.

19. The system of claim 15, wherein the raw melting curve is smoothed and a derivative of the smoothed melting curve is calculated by using a Savitzky-Golay filter prior to calculating the normalized melting curve.

20. The system of claim 15, wherein raw melting curves are simultaneously generated in two or more samples.

21. The system of claim 20, wherein a temperature bias between the at least two samples is calculated and shifted normalized melting curves and shifted normalized derivatives are generated based on the temperature bias.

22. The system of claim 20, wherein the normalized melting curves corresponding to different samples are resampled on a common temperature scale.

23. The system of claim 20, wherein raw melting curves corresponding to different samples are resampled on a common temperature scale prior to calculating the normalized melting curves.

24. The system of claim 23, wherein resampling on a common temperature scale is performed by linear interpolation.

25. The system of claim 15, wherein the at least one sample is in at least one microchannel of the biochip.

26. The system of claim 25, wherein raw melting curves are simultaneously generated in two or more microchannels of the biochip.

27. The system of claim 25, wherein the normalized melting curves corresponding to different microchannels are resampled on a common temperature scale.

28. The system of claim 27, wherein raw melting curves corresponding to different microchannels are resampled on a common temperature scale prior to calculating the normalized melting curves.
